(19) United States
(12) Patent Application Publication
(10) Pub. No.: US 2006/0047816 A1
(43) Pub. Date: Mar. 2, 2006

(54) Method and apparatus for generating and distributing meeting minutes from an instant messaging session

(75) Inventors: Craig M. Lawton, Raleigh, NC (US); Jonathan Andrew Lewis, Morrisville, NC (US); Jesse B. Overby III, Raleigh, NC (US); Christopher Andrew Peters, Pflugerville, TX (US); Lorin Evan Ullmann, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/870,531

(22) Filed: Jun. 17, 2004

(51) Int. Cl. G06F 15/16

(52) U.S. Cl. 709/227

(57) ABSTRACT

A method, apparatus, and computer instructions for distributing meeting minutes from an instant messaging session. Meeting minutes are generated using data from the instant messaging session, in response to receiving a user input to distribute text from the instant messaging session. The meeting minutes are then distributed by email to a list of recipients.

### BACKGROUND OF THE INVENTION

1. Technical Field

The present invention relates generally to an improved data processing system and in particular, to a method, apparatus, and computer instructions for processing messages from a session. Still more particularly, the present invention provides an improved method, apparatus, and computer instructions for generating and distributing meeting minutes from an instant messaging session.

2. Description of Related Art

Instant messaging is an online chat medium allowing users to communicate with each other and to collaborate in real-time over a network data processing system. Instant messaging is commonly used over the Internet. Instant messaging applications monitor and report the status of users that have established each other as online contacts. This information is typically presented to a user in a window. Instant messaging applications also are often employed by users conducting business. By utilizing instant messaging, business users can view each other's availability and initiate a text conversation with colleagues or customers when a desired contact becomes available. Millions of users communicate using instant messaging systems every day. With instant messaging becoming an important part of both personal and business communications, functionality and usability enhancements are important to the continued success of this type of communication tool.

Instant messaging systems are commonly used for meetings between users at remote locations. For example, a number of users may use Sametime, a Lotus instant messaging program available from International Business Machines Corporation, to discuss various topics during an online meeting. When a meeting is over, only the users who were involved in the meeting have logs of the conversation. If others want to reference this meeting, one of the users participating in the meeting must save this log and send it to those who want a copy of the log.

Such a process may be tedious and often requires prior knowledge that meeting minutes are desired, so that one of the meeting participants remembers to save the log of the meeting. Therefore, it would be advantageous to have an improved method, apparatus, and computer instructions for generating and distributing meeting minutes from an instant messaging session.

### SUMMARY OF THE INVENTION

The present invention provides a method, apparatus, and computer instructions for distributing meeting minutes from an instant messaging session. Meeting minutes are generated using data from the instant messaging session, in response to receiving a user input to distribute text from the instant messaging session. The meeting minutes are then distributed by email to a list of recipients.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a network of data processing systems in which the present invention may be implemented;

FIG. 2 is a block diagram of a data processing system that may be implemented as a server, in accordance with a preferred embodiment of the present invention;

FIG. 3 is a block diagram illustrating a data processing system in which the present invention may be implemented;

FIG. 4 is a block diagram illustrating components used in an instant messaging system in accordance with a preferred embodiment of the present invention;

FIG. 5 is a diagram illustrating an instant messaging client in accordance with a preferred embodiment of the present invention;

FIGS. 6A-6C are diagrams illustrating user interfaces for generating and distributing meeting minutes in accordance with the preferred embodiment;

FIG. 7 is a high level flowchart of a process for distributing meeting minutes in accordance with the preferred embodiment of the present invention;

FIG. 8 is a flowchart of a process for generating and distributing meeting minutes in accordance with the preferred embodiment of the present invention;

FIG. 9 is a flowchart of a process for receiving meeting minutes for approval in accordance with the preferred embodiment of the present invention;

FIG. 10 is a flowchart of a process for indicating status in accordance with a preferred embodiment of the present invention; and

FIG. 11 is a flowchart of a process for generating statistics for an instant messaging session in accordance with the preferred embodiment of the present invention.

### DETAILED DESCRIPTION OF THE PREFERRED EMBODIMENT

With reference now to the figures, FIG. 1 depicts a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers or personal digital assistants (PDA) devices. In the depicted example, server 104 provides data, such as boot files, operating system images, and applications to clients 108-112. Clients 108, 110, and 112 are clients to server 104. Server 104 may act as an instant messaging server to facilitate the exchange of messages between users at clients, such as clients 108, 110, and 112. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

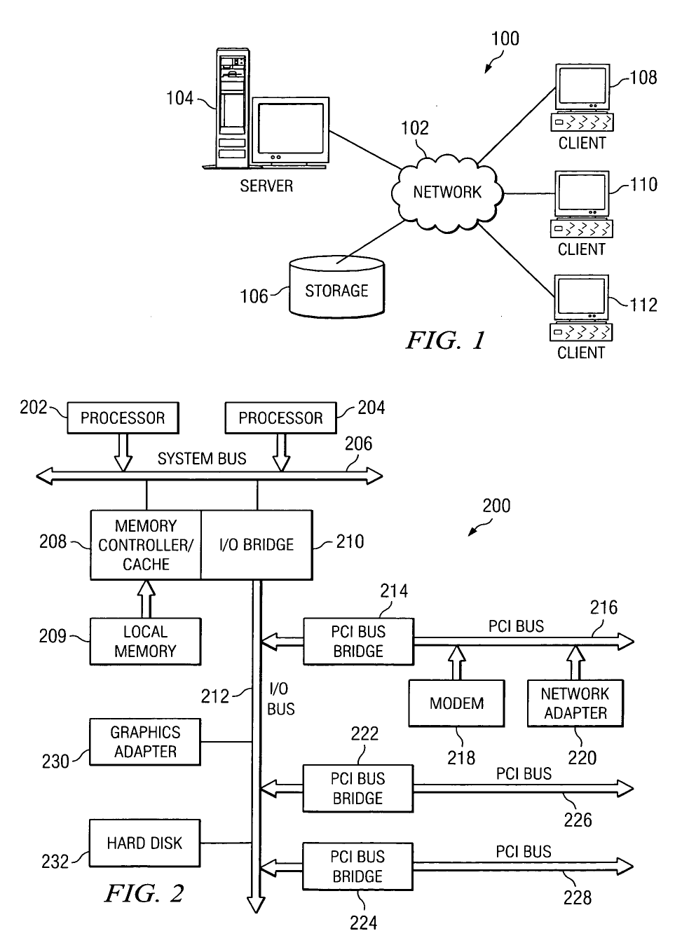

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

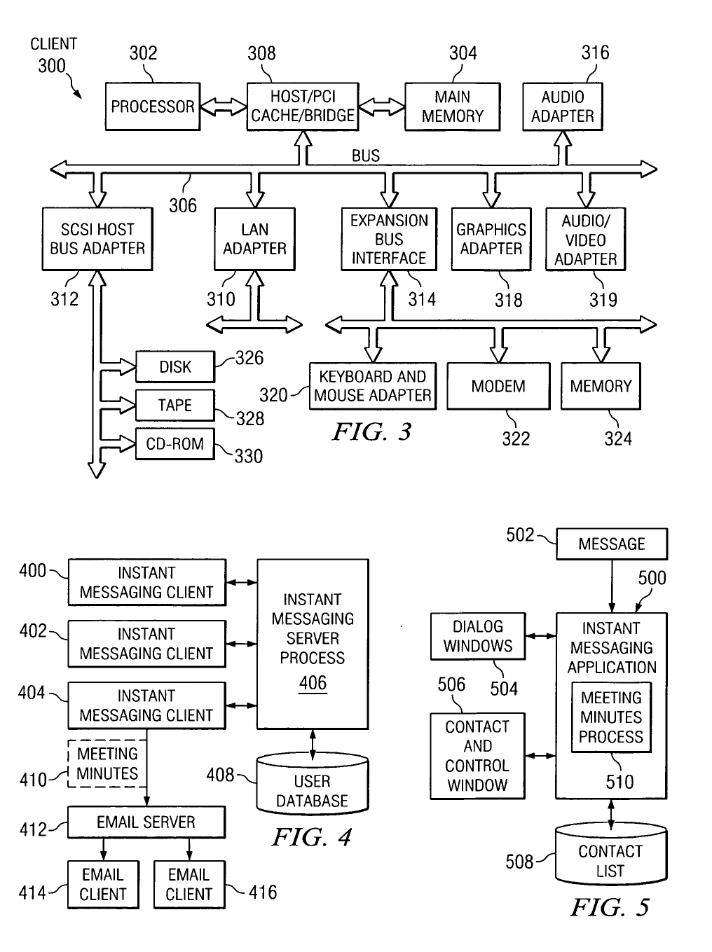

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method, apparatus, and computer instructions for distributing meeting minutes from an instant messaging session. After a meeting through an instant messaging session has completed, a user input may be employed to initiate generation of meeting minutes and the distribution of these minutes through email. This user input may be the manipulation of a button through the instant messaging program. This feature may be implemented in many different instant messaging systems including, for example, but not limited to Sametime. Meeting minutes, as used herein, are a record of a meeting that occurred during an online session, such as an instant messaging session. In addition to the record or text exchanged between participants, other information may be included. This information may include, for example, statistics regarding the meeting. These statistics may include, for example, how fast responses arrived, number of words typed by each participant, and other statistics regarding the participants.

The meeting minutes may be sent to some list of recipients. These recipients may include participants of the meeting and those who were not participants of the meeting. For example, a team member who was out sick or a manager may wish to have a copy of the meeting minutes. The list of recipients may be selected by a user entering email addresses or from a mailing list.

Additionally, the generated meeting minutes may be distributed by the mechanism of the present invention to participants for editing and approval. After each participant has had an opportunity to edit the meeting minutes, these meeting minutes are redistributed for approval in the illustrative examples. When the meeting minutes have been approved, these meeting minutes are sent or distributed to recipients on the list by email. Further, as part of the editing and approval process, participants may modify the recipients who are to receive the meeting minutes.

Turning now to FIG. 4, a block diagram illustrating components used in an instant messaging system in accordance with a preferred embodiment of the present invention is shown. In this illustrative example, a user at instant messaging client 400 may send or exchange messages with other users at instant messaging clients 402 and 404. These instant messaging clients may be executing on a data processing system, such as data processing system 300 in FIG. 3. The exchange of messages in these examples is facilitated through instant messaging server process 406. This process allows for users to find other users within the instant messaging system, as well as aid in the exchange of messages between different users.

Depending on the particular instant messaging system, instant messaging server process 406 may only be involved in providing an indication of when particular users are online and for establishing initial contacts. Users contacting users already on a buddy list may contact those users directly after seeing that a particular user is online. Instant messaging server process 406 may be located on a server, such as data processing system 200 in FIG. 2.

In these examples, the different users registered to the instant messaging system are stored in user database 408. This user database provides information needed to search for and find other users, as well as contact users when they are online.

In these illustrative examples, users at instant messaging clients 400, 402, and 404 are participants to a meeting occurring during an instant messaging session. In response to a user input from a user at instant messaging client 404, meeting minutes 410 are automatically generated. These meeting minutes may be automatically sent to email server 412 for distribution to recipients, such as those at email clients 414 and 416. In the illustrative examples, additional steps occur before the distribution of meeting minutes 410 to the recipients.

In particular, instant messaging client 404 distributes meeting minutes 410 to instant messaging clients 400 and 402. The users at these clients may edit or approve meeting minutes 410. These meeting minutes include a list of recipients for the minutes. If no edits occur, meeting minutes 410 have been approved by the users and instant messaging client 404 sends meeting minutes 410 to email server 412 for distribution. If edits are made, the users at instant messaging clients 400, 402, and 404 are queried for approval of the modifications. In the illustrative examples, the edits may be made using a redline/strikeout mechanism to allow for easy review and approval of changes. As part of the edits to meeting minutes 410, users may add or change recipients who are to receive the meeting minutes. If more edits are made, these edits are incorporated into meeting minutes 410 with the users then being queried again for approval.

Due to the real-time nature of instant messaging and the fact that the mechanism of the present invention can provide recordings of a meeting, new statistics can be generated. For example, these statistics may include the participant who is most talkative, the number of words typed, and how fast the responses arrived. Also, a moderator may signal the move from one topic to another in a manner similar to following an agenda. Overall status can be queried from all participants on a topic. The status may be indicated through colors, such as green, yellow, and red. In addition to colors, status may be indicated through other mechanisms such as, for example, a numbering scale. This numbering scale may be implemented using a slide bar presented to the user.

As the moderator for the online meeting moves through the agenda of the meeting, different types of status may be recorded for all participants. For example, one type of status that may be recorded is the level of agreement that participants have on a particular topic. With a color status scheme, a strong level of agreement may be indicated by a participant choosing the green button while a particular topic is in discussion. If a red button is chosen, this selection indicates that the participant disagrees with the particular idea or topic being discussed. The values for each participant may be displayed next to their screen names so that all participants could see the overall level of agreement on the particular topic.

Another status that may be recorded is how completely or thoroughly a participant feels a particular topic has been covered during the online meeting. Using this type of status system, a participant selects a red button to indicate that the participant feels that topic needs more discussion. A green button would indicate that the participant feels that the topic has been sufficiently covered and that the next item on the agenda should be started.

By matching participant status values with information inferred about each participant (using the company directory) a more complete set of meeting minutes can be generated. Information that can be inferred about each participant may include, for example, the participant's organization, department, work location, and/or job responsibilities. Once the meeting minutes have been generated to include all of the participant's information, useful statistics can be extracted about the meeting. For instance, in a cross department meeting, the level of agreement on a particular topic based on departments may be identified. For example, 80 percent of department A agreed with topic 4, while only 40 percent of department B agreed. It could also be determined that of the 40 percent that agreed from department B, 100 percent were managers.

Information may be inferred from various sources. For example, the organization to which participants belong may be identified based on the participants' phonebook entries. Also, using the organization trees, the status can be rolled up.

Other status information that may be used is an aggregate status of people on the same team. For example, all of the people who have the same manager and are in the same department may be considered to be on the same team. In this illustrative example, a development team may be displayed using green, a test team may be displayed using yellow, and a sales team may be displayed using red. The level of agreement within each team may be identified in addition to an overall level of agreement for one or more topics in the meeting.

Buttons with standard questions are provided to help autogenerate the minutes. These quick response buttons with standard questions can be used to create often used responses quickly without typing. For example, certain phrases/ideas are repeatedly used. These types of phrases and ideas are candidates for inclusion on standard message buttons. These quick response buttons in the illustrative examples provide a more productive and efficient session for the user, as well as standardize these responses across sessions.

For example, a block of messages could be designated an action item, with an owner/due date assigned in the meeting. Customizable quick buttons can be provided to allow the user to add responses that they personally use more often.

The meeting minutes and other information are stored persistently in these illustrative examples. For example, the actual messages, status, and meeting topics may be stored in a database. This database may be stored at an instant messaging client, such as instant messaging client 400 or at a server, such as instant messaging server process 406.

Turning next to FIG. 5, a diagram illustrating an instant messaging client is depicted in accordance with a preferred embodiment of the present invention. The components illustrated in FIG. 5 may be found in an instant messaging client, such as instant messaging clients 400, 402, or 404 in FIG. 4. These components may be implemented in a data processing system, such as data processing system 300 in FIG. 3.

In the illustrative example, instant messaging application 500 processes messages, such as message 502, received from users located on remote data processing systems. As messages are received, these messages are presented in dialog windows 504. Additionally, dialog windows 504 provide an interface for a user to input text to send messages to other users.

Contact and control window 506 is presented by instant messaging application 500 to provide the user with a list of user names, as well as other information. Contact and control window 506 also provides an interface to allow a user to set different preferences. For example, the user may set passwords required to access different names used in instant messaging sessions.

Also, a user may employ contact and control window 506 to set other preferences, such as colors and fonts used in instant messaging application 500. These preferences also may include whether a picture is to be sent when a session is initiated with another user. Depending on the implementation, the preference may be set to allow a user who receives messages to retrieve images of the senders from a remote database or a local cache.

Further, a list of names presented by contact and control window 506 is stored in contact list 508 in these examples. Additional user or screen names may be added to or deleted from contact list 508. This contact list is employed in presenting the list of names within contact and control window 506.

In accordance with a preferred embodiment of the present invention, the mechanism for generating and distributing meeting minutes may be implemented within instant messaging application 500. In particular, this mechanism may be placed in meeting minutes process 510 in instant messaging application 500. Controls for initiating meeting minutes process 510 may be provided through a graphical user interface, such as a button or other control presented in dialogue windows 504 or contact and control window 506. Meeting minutes process 510 also may include a component to query sources, such as websites or databases, to obtain reporting structures or organization charts. This information may be used to generate and record status for participants. With this type of information, aggregate status of people within a related group may be identified as a statistic associated with the meeting.

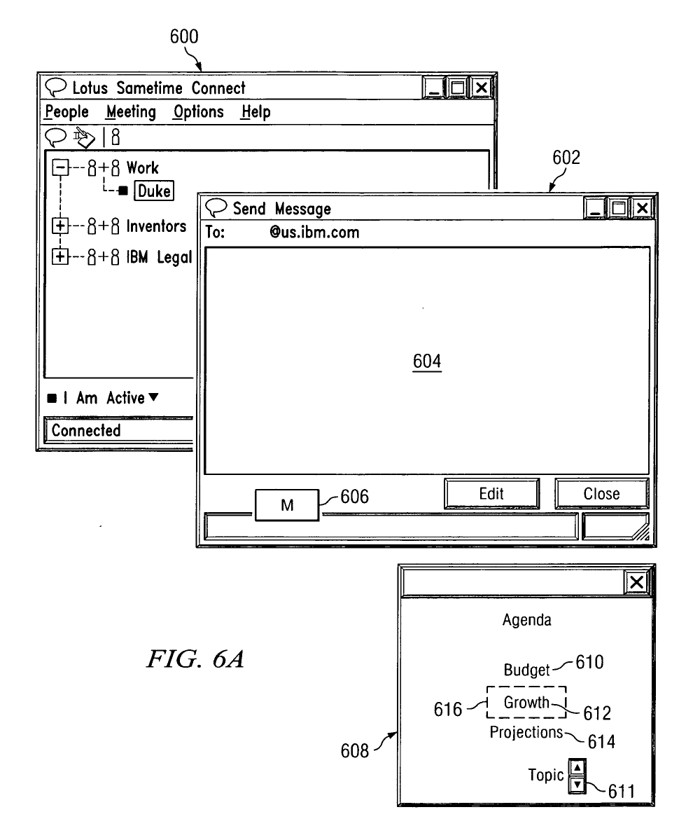

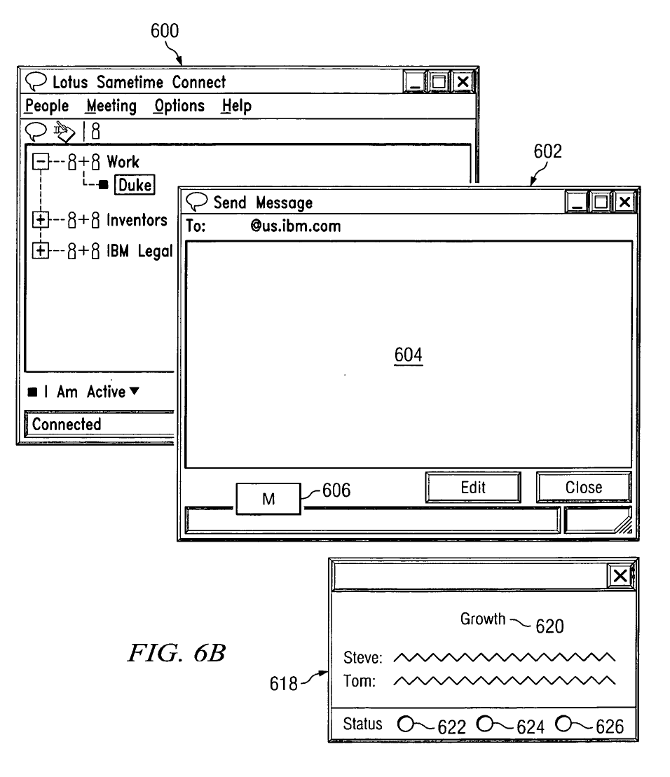

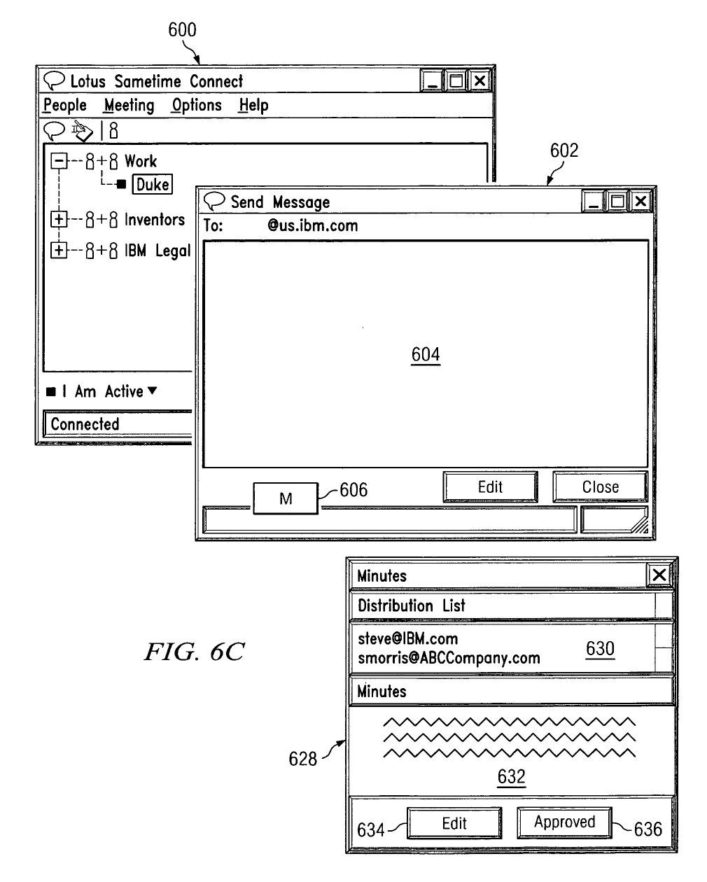

Turning now to FIGS. 6A-6C, diagrams illustrating user interfaces for generating and distributing meeting minutes is depicted in accordance with the preferred embodiment of the present invention. In FIG. 6A, contact and control window 600 shows a list of contacts and is an example of the user interface provided by contact and control window 506 in FIG. 5 for Sametime. Dialog window 602 illustrates an example of a dialog window for dialog windows 504 in FIG. 5. Text typed by participants are entered and displayed in section 604 of dialog window 602.

With respect to the view by the moderator, agenda window 608 is displayed with topics 610, 612, and 614 in these examples. Topic 610 is budget, topic 612 is growth, and topic 614 is projections in these illustrative examples. In addition, agenda window 608 may include topic control 611. This control provides the moderator a mechanism for moving through topics that are to be covered in a meeting. Such a feature is especially useful if all of the topics cannot be displayed within agenda window 608. The moderator may select the topic for discussion using a pointing device.

The topic that is currently being discussed is the one highlighted in agenda window 608. In this illustrative example, topic 612 is highlighted using dotted line 616. The indicator used may differ depending on the implementation. For example, the current topic may be indicated through placing topic 612 in bold or by displaying the text in a different color from the other topics. These topics may be identified to the attendees through indicators or tags that are displayed in their displays.

In FIG. 6B, a view from the attendee's point of view is displayed. Window 618 shows that topic 612 in FIG. 6A is being discussed on line 620. Additionally, this view also includes status buttons 622, 624, and 626. Status button 622 is a green button, status button 624 is a yellow button, and status button 626 is a red button. These buttons may be selected by the attendees to indicate status for a parameter, such as how well the topic has been discussed. Of course, other types of status may be indicated such as the amount of agreement reached in the discussion or the amount of interest for a particular topic. The status may be indicated per topic, for the entire meeting, or on some other basis depending on the particular implementation.

In FIG. 6C, when a session has completed, meeting minutes are automatically generated in response to a selection of minutes button 606. In this illustrative example, minutes button 606 is presented in dialog window 602. Of course, this control may be presented elsewhere, such as in contact and control window 600. In response to selection of this button, minutes window 628 is presented to the different participants. These meeting minutes include distribution list 630 and minutes 632. A participant may select edit button 634 to edit the minutes or approve the minutes in their current form by selecting approved button 636. The edits made through edit button 634 may include the addition of recipients in distribution list 630.

When edits occur, all of the participants are prompted to approve the edited meeting minutes. This prompt may be made through various mechanisms. For example, the prompt may be an audible sound or message requesting approval of edits. In another example, minutes window 628 may be redisplayed with the edits highlighted for review and approval. Alternatively, the prompt may be a pop up window requesting approval of the minutes. Also, approved button 636 may flash or change colors indicating that edits are present and approval is needed.

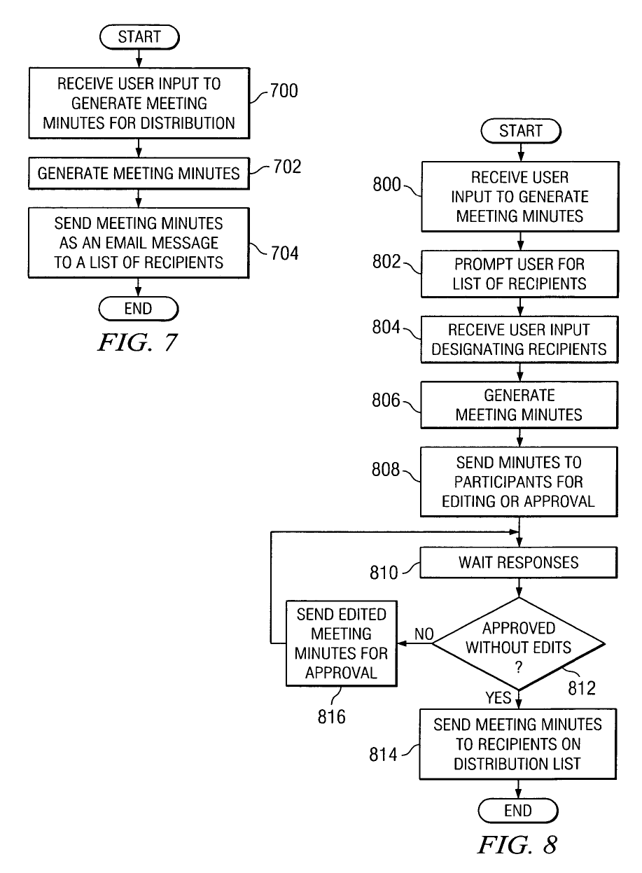

With reference now to FIG. 7, a high level flowchart of a process for distributing meeting minutes is depicted in accordance with the preferred embodiment of the present invention. The process illustrated in FIG. 7 may be implemented in an instant messaging process, such as meeting minutes process 510 in FIG. 5.

The process begins by receiving user input to generate meeting minutes for distribution (step 700). This user input may be received through a control, such as minutes button 606 in FIGS. 6A-6C. Next, meeting minutes are generated from the text typed by the participants during the instant messaging session (step 702). Then, meeting minutes are sent as an email message to a list of recipients (step 704) with the process terminating thereafter.

The steps described in FIG. 7 are for a simplified process for distributing meeting minutes. Additional steps may be included, such as those for approving and editing meeting minutes. Examples of additional steps used to generate and distribute meeting minutes are described below.

With reference now to FIG. 8, a flowchart of a process for generating and distributing meeting minutes is depicted in accordance with the preferred embodiment of the present invention. The process illustrated in FIG. 8 may be implemented in an instant messaging process, such as meeting minutes process 510 in FIG. 5. This process is initiated in the instant messaging client at which a user initiates the generation of meeting minutes in these illustrative examples.

The process begins by receiving user input to generate meeting minutes (step 800). Next, the user is prompted for a list of recipients (step 802). In this example, the user is the same user initiating the process to generate meeting minutes. Then, user input is received designating recipients (step 804). This user input may be, for example, the user typing in email addresses for recipients, selecting recipients from an address book, or selecting a mailing list.

Next, meeting minutes are generated (step 806). Then, meeting minutes are sent to participants for editing or approval (step 808). Next, wait for responses (step 810). When the responses are received, a determination is made as to whether meeting minutes are approved without edits (step 812). If meeting minutes are approved without edits, then meeting minutes are then sent to recipients on the distribution list (step 814) with the process terminating thereafter.

Referring back to step 812, if meeting minutes are not approved without edits, then edited meeting minutes are sent for approval (step 816) with the process then proceeding to step 810 as described above. In step 816, a new minutes window, such as minutes window 628 in FIG. 6C, may be displayed with the edited minutes to prompt the user for approval or additional edits. Alternatively, the edits may be displayed in the minutes window as edits are made with a prompting made for approval when all of the edits are completed.

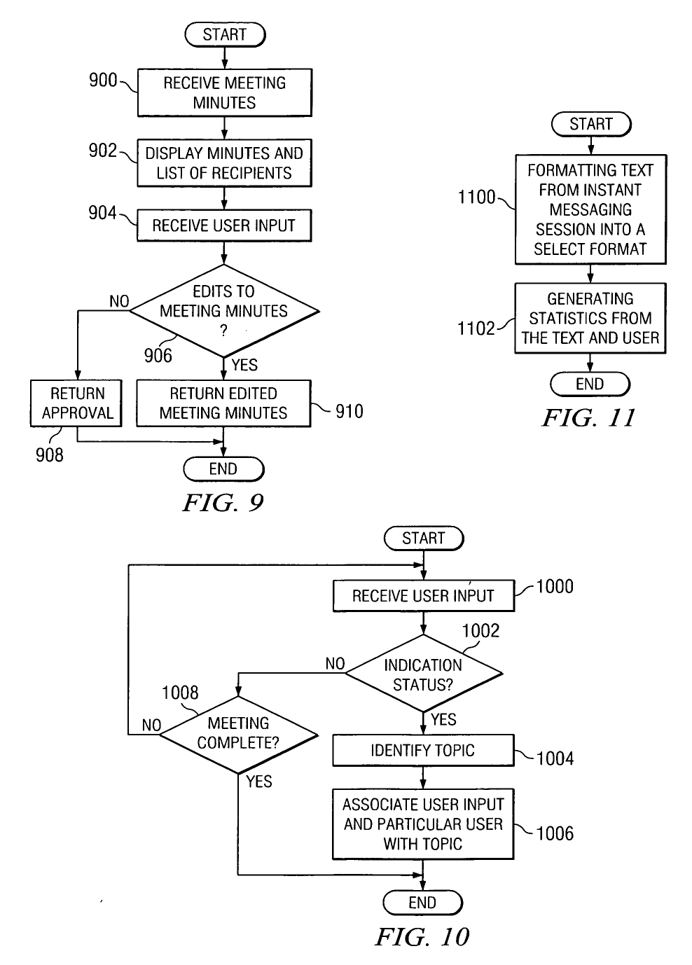

With reference now to FIG. 9, a flowchart of a process for receiving meeting minutes for approval is depicted in accordance with the preferred embodiment of the present invention. The process illustrated in FIG. 9 may be implemented in an instant messaging process, such as meeting minutes process 510 in FIG. 5. This process is initiated at an instant messaging client that receives meeting minutes for editing or approval.

The process begins by receiving meeting minutes (step 900). Next, minutes and a list of recipients are displayed (step 902). Then, user input is received (step 904). A determination is made as to whether edits have been made to the meeting minutes (step 906). In these illustrative examples, this determination may be made based on the actions of the user. If the user selects an approval button, such as approved button 636 in FIG. 6C, then the user has approved the meeting minutes received by the instant messenger client.

If the user has made edits to the meeting minutes, then an approval of the minutes as received has not occurred. In these illustrative examples, these edits may include either or both of the typed text forming the minutes and the list of recipients. If edits have not been made to the meeting minutes, then an approval of the received meeting minutes is returned (step 908) with the process terminating thereafter.

Referring back to step 906, if edits do need to be made to the meeting minutes, then edited meeting minutes are returned (step 910) with the process terminating thereafter.

With reference next to FIG. 10, a flowchart of a process for indicating status is depicted in accordance with a preferred embodiment of the present invention. The process illustrated in FIG. 10 may be implemented in an instant messaging process, such as meeting minutes process 510 in FIG. 5.

The process begins by receiving a user input (step 1000). In these illustrative examples, the user input is to an instant messaging system interface, such as those illustrated in FIGS. 6A-6C. This user input may take many forms, such as, for example, entering text or manipulating controls, such as a button. A determination is made as to whether a user input is one to indicate status (step 1002). This type of input is received through controls in the illustrative examples. These controls are, for example, status buttons 622, 624, and 626 in FIG. 6B.

If the user input indicates status, the current topic is identified (step 1004). The user input indicating status and the particular user generating the input are associated with the topic (step 1006) with the process terminating thereafter.

With reference again to step 1002 if the user input does not indicate status, a determination is made as to whether the user input indicates that the meeting has completed (step 1008). If the meeting has completed, the process terminates. Otherwise, the process returns to step 1000 as described above.

Although the illustrative example shows status information being gathered with respect to topics, status may be gathered for any purpose with respect to the meeting. For example, the status may be a level of agreement with a particular topic or how well a particular topic has been covered. Status also may include, for example, a level of approval for the entire agenda.

With reference now to FIG. 11, a flowchart of a process for generating statistics for an instant messaging session is depicted in accordance with the preferred embodiment of the present invention. The process illustrated in FIG. 11 may be implemented in an instant messaging process, such as meeting minutes process 510 in FIG. 5.

The process begins by formatting text from an instant messaging session into a select format (step 1100). This format may be, for example, one for a particular type of word processing document. Next, statistics from the text and user input are generated (step 1102) with the process terminating thereafter. These statistics may include, for example, the participant typing the most text, the total number of words in the minutes, the total number of words typed by each participant, the total time of the instant messaging session, and how fast responses were made. Other statistics include status as described above. The status may include, for example, the amount of approval for topics discussed or how well topics were covered during the meeting. The statistics also may include the number of words typed in each topic discussed, as well as how much time was spent on each topic. With statistics, indications of status are collected from the text and user input entered by the participants.

Thus, the present invention provides an improved method, apparatus, and computer instructions for automatically generating and distributing meeting minutes. The mechanism of the present invention allows for participants to review and edit meeting minutes and approve any changes. The meeting minutes are then distributed by the mechanism of the present invention to a list of recipients by email. This mechanism allows for an efficient generation and distribution of meeting minutes without requiring a user to save a log of an instant messaging session and having to later send the minutes as an attachment. Further, this mechanism allows for editing an approval of minutes with these different steps all occurring through the instant messaging client.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for distributing meeting minutes from an instant messaging session, the method comprising:
responsive to receiving a user input to distribute text from the instant messaging session, generating meeting minutes using data from the instant messaging session; and
distributing the meeting minutes by email to a list of recipients.

2. The method of claim 1, wherein the distributing step includes:
sending the meeting minutes to participants in the instant messaging session for review;
receiving changes to the meeting minutes;
responsive to receiving changes to the meeting minutes, requesting approval of the meeting minutes from the participants to form approved meeting minutes; and
sending the approved meeting minutes by email to the list of recipients.

3. The method of claim 1 further comprising:
generating statistics from the instant messaging session; and
including the statistics in the meeting minutes.

4. The method of claim 3, wherein the statistics include at least one of a number of words, how fast responses arrived, a participant who typed a largest number of words, and a number of topics covered.

5. The method of claim 1, wherein the list of recipients includes participants to the instant messaging session.

6. The method of claim 1, wherein the list of recipients includes non-participants to the instant messaging session.

7. The method of claim 1, wherein the meeting minutes includes at least one of status information and topics covered during the instant messaging session.

8. The method of claim 1 further comprising:
collecting status information generated during the instant messaging session.

9. The method of claim 8, wherein the status information includes at least one of approval of topics, membership of participants within an organization based on information from an organization chart, and coverage of topics by participants to the instant messaging session.

10. A data processing system for distributing meeting minutes from an instant messaging session, the data processing system comprising:
generating means, responsive to receiving a user input to distribute text from the instant messaging session, for generating meeting minutes using data from the instant messaging session; and
distributing means for distributing the meeting minutes by email to a list of recipients.

11. The data processing system of claim 10, wherein the distributing means includes:
first sending means for sending the meeting minutes to participants in the instant messaging session for review;
receiving means for receiving changes to the meeting minutes;
requesting means, responsive to receiving changes to the meeting minutes, for requesting approval of the meeting minutes from the participants to form approved meeting minutes; and
second sending means for sending the approved meeting minutes by email to the list of recipients.

12. The data processing system of claim 10, wherein the generating means is a first generating means and further comprising:
second generating means for generating statistics from the instant messaging session; and
including means for including the statistics in the meeting minutes.

13. The data processing system of claim 12, wherein the statistics include at least one of a number of words, how fast responses arrived, a participant who typed a largest number of words, and a number of topics covered.

14. The data processing system of claim 10, wherein the list of recipients includes participants to the instant messaging session.

15. The data processing system of claim 10, wherein the list of recipients includes non-participants to the instant messaging session.

16. The data processing system of claim 10, wherein the meeting minutes includes at least one of status information and topics covered during the instant messaging session.

17. The data processing system of claim 10 further comprising:
collecting means for collecting status information generated during the instant messaging session.

18. The data processing system of claim 17, wherein the status information includes at least one of approval of topics, membership of participants within an organization based on information from an organization chart, and coverage of topics by participants to the instant messaging session.

19. A computer program product in a computer readable medium for distributing meeting minutes from an instant messaging session, the computer program product comprising:
first instructions, responsive to receiving a user input to distribute text from the instant messaging session, for generating meeting minutes using data from the instant messaging session; and
second instructions for distributing the meeting minutes by email to a list of recipients.

20. The computer program product of claim 19, wherein the second instructions includes:
first sub-instructions for sending the meeting minutes to participants in the instant messaging session for review;
second sub-instructions for receiving changes to the meeting minutes;
third sub-instructions, responsive to receiving changes to the meeting minutes, for requesting approval of the meeting minutes from the participants to form approved meeting minutes; and
fourth sub-instructions for sending the approved meeting minutes by email to the list of recipients.

21. The computer program product of claim 19 further comprising:
third instructions for generating statistics from the instant messaging session; and
fourth instructions for including the statistics in the meeting minutes.

22. The computer program product of claim 21, wherein the statistics include at least one of a number of words, how fast responses arrived, a participant who typed a largest number of words, and a number of topics covered.

23. The computer program product of claim 19, wherein the list of recipients includes participants to the instant messaging session.

24. The computer program product of claim 19, wherein the list of recipients includes non-participants to the instant messaging session.

25. A data processing system comprising:
a bus system;
a memory connected to the bus system, wherein the memory includes a set of instructions; and
a processing unit connected to the bus system, wherein the processing unit executes the set of instructions to generate meeting minutes using data from a instant messaging session, in response to receiving a user input to distribute text from the instant messaging session; and distribute the meeting minutes by email to a list of recipients.
